(19) United States
(12) Patent Application Publication
(10) Pub. No.: US 2025/0315323 A1
(43) Pub. Date: Oct. 9, 2025

(54) CLOUD APPLICATION PROVISIONING METHOD AND SYSTEM

(71) Applicant: SAMSUNG SDS CO., LTD., Seoul (KR)

(72) Inventors: Kook Young CHO, Seoul (KR); Sung Duck KIM, Seoul (KR); Jang Bong HA, Seoul (KR); Rok Dam BAEK, Seoul (KR); Hee Suk LEE, Seoul (KR)

(73) Assignee: SAMSUNG SDS CO., LTD., Seoul (KR)

(21) Appl. No.: 19/075,210

(22) Filed: Mar. 10, 2025

(30) Foreign Application Priority Data
Apr. 8, 2024 (KR) 10-2024-0047680
May 22, 2024 (KR) 10-2024-0066141

(51) Int. Cl. G06F 9/54; G06F 9/445

(52) U.S. Cl. CPC G06F 9/546; G06F 9/44589; G06F 9/547; G06F 2209/547

(57) ABSTRACT

There is provided a cloud application provisioning method performed by a computing system. The cloud application provisioning method performed by a computing system, the cloud application provisioning method may comprise acquiring a message related to a cloud application, acquiring a workflow for the cloud application based on the message, determining at least one protocol specification for implementing the workflow, determining executable code for the cloud application using the determined at least one protocol specification and the workflow and provisioning the cloud application using the determined executable code.

### CROSS-REFERENCE TO RELATED APPLICATIONS

This application claims priority from Korean Patent Application No. 10-2024-0047680 filed on Apr. 8, 2024 and Korean Patent Application No. 10-2024-0066141 filed on May 22, 2024 in the Korean Intellectual Property Office, and all the benefits accruing therefrom under 35 U.S.C. 119, the contents of which in its entirety are herein incorporated by reference.

### BACKGROUND

### 1. Field

The present disclosure relates to a cloud application provisioning method, and more specifically, to a cloud application provisioning method and system for automatically provisioning cloud applications based on messages related to the cloud applications.

### 2. Description of the Related Art

A cloud computing system, which includes multiple processors, memories, and storages, allows a specific user to construct a virtual computing system for their work environment. For example, various cloud applications utilizing the resources included in the cloud computing system can be made available, and users can purchase specific cloud applications to build a virtual computing system tailored to their needs.

For such a cloud computing environment, cloud infrastructure, protocols required for infrastructure control, and program code implementing these protocols must be pre-stored in the cloud computing system. For example, in various situations, when a cloud service provider releases a new cloud application, protocols and program code suitable for each infrastructure attribute must be developed, and the developed protocols and program code must be continuously added to the cloud computing system.

However, whenever a new cloud infrastructure is added to the cloud computing system, developing protocols and program code to control the new infrastructure becomes a factor that significantly increases labor and time consumption.

Accordingly, a technology is required that can automatically generate protocols and program code necessary for controlling new infrastructure when it is introduced.

### SUMMARY

An objective of the present disclosure is to provide a provisioning method and system capable of automatically generating executable code for controlling new cloud infrastructure.

Another objective of the present disclosure is to provide a provisioning method and system that can be compatible with various cloud infrastructure by utilizing standardized messages and protocols.

Another objective of the present disclosure is to provide a provisioning method and system that minimize error by performing accurate verification during a provisioning process.

Another objective of the present disclosure is to provide a method and system for rapidly and accurately provisioning cloud applications using an artificial intelligence (AI) engine.

Another objective of the present disclosure is to provide a provisioning method and system capable of generating executable code for controlling cloud infrastructure in a fast, accurate, and convenient manner.

The objectives of the present disclosure are not limited to those mentioned above, and other objectives not explicitly stated will be clearly understood by those skilled in the art based on the following description.

According to an aspect of the present disclosure, there is provided a cloud application provisioning method performed by a computing system, the cloud application provisioning method may comprise acquiring a message related to a cloud application, acquiring a workflow for the cloud application based on the message, determining at least one protocol specification for implementing the workflow, determining executable code for the cloud application using the determined at least one protocol specification and the workflow and provisioning the cloud application using the determined executable code.

In some embodiments, the acquiring the workflow may comprise extracting a common attribute for the cloud application from the message and acquiring the workflow for the cloud application based on the extracted common attribute.

In some embodiments, the acquiring the workflow may comprise inputting the extracted common attribute into an artificial intelligence (AI) engine and acquiring the workflow from the AI engine.

In some embodiments, if it is determined that a workflow related to the extracted common attribute is not found in a database, the extracted common attribute may be input into the AI engine.

In some embodiments, the determining the at least one protocol specification may comprise extracting a common feature and a functional attribute for the cloud application from the message, acquiring at least one protocol template for the cloud application based on the extracted common and functional attributes and determining the at least one protocol specification using the at least one protocol template and the extracted functional attribute.

In some embodiments, the acquiring the at least one protocol template may comprise inputting the extracted common and functional attributes into an AI engine and acquiring the at least one protocol template from the AI engine.

In some embodiments, if it is determined that a protocol related to the extracted common and functional attributes is not found in a database, the extracted common and functional attributes may be input into the AI engine.

In some embodiments, the determining the at least one protocol specification may comprise writing a first protocol specification, if verification of the first protocol specification fails, writing a second protocol specification and determining the second protocol specification as a protocol specification for implementing the workflow in response to verification of the second protocol specification being successful.

In some embodiments, first text requesting verification of the first protocol specification may be input into the AI engine, and the AI engine may output a verification failure result for the first protocol specification, and outputs a verification success result for the second protocol specification upon receiving second text requesting verification of the second protocol specification.

In some embodiments, the determining the executable code for the cloud application may comprise acquiring a code template using at least one of the determined at least one protocol specification or the workflow and determining the executable code for the cloud application based on the code template and the determined at least one protocol specification.

In some embodiments, the acquiring the code template may comprise inputting the determined at least one protocol specification and the workflow into an AI engine and acquiring the code template from the AI engine.

In some embodiments, the determining the executable code for the cloud application may comprise writing first executable code using the determined at least one protocol specification and the workflow, if verification of the first executable code fails, writing second executable code using the determined at least one protocol specification and the workflow, and determining the second executable code as executable code for the cloud application in response to verification of the second executable code being successful.

In some embodiments, third text requesting verification of the first executable code may be input into the AI engine, and the AI engine may output a verification failure result for the first executable code, and outputs a verification success result for the second executable code upon receiving fourth text requesting verification of the second executable code.

In some embodiments, the determining the at least one protocol specification may comprise identifying a plurality of task procedures included in the workflow and determining at least one protocol specification for each of the plurality of task procedures.

In some embodiments, the cloud application provisioning method may further comprise after the provisioning the cloud application, storing training data including at least one of the workflow, the protocol specification, the executable code, or the common and functional attributes extracted from the message, wherein the stored training data may be used to fine-tune the AI engine.

According to an aspect of the present disclosure, there is provided a computing system. The computing system may comprise at least one processor and a memory storing a computer program executed by the at least one processor, wherein the computer program may comprise instructions for operations of acquiring a message related to a cloud application, acquiring a workflow for the cloud application based on the message, determining at least one protocol specification for implementing the workflow, determining executable code for the cloud application using the determined at least one protocol specification and the workflow and provisioning the cloud application using the determined executable code.

In some embodiments, the operation of determining the at least one protocol specification may comprise extracting a common attribute and a functional attribute for the cloud application from the message, acquiring at least one protocol template for the cloud application based on the extracted common and functional attributes and determining the at least one protocol specification using the at least one protocol template and the extracted functional attribute.

In some embodiments, the operation of determining the at least one protocol specification may comprise writing a first protocol specification, if verification of the first protocol specification fails, writing a second protocol specification, and determining the second protocol specification as a protocol specification for implementing the workflow in response to verification of the second protocol specification being successful.

In some embodiments, the operation of determining the executable code for the cloud application may comprise acquiring a code template using at least one of the determined at least one protocol specification or the workflow, and determining the executable code for the cloud application based on the code template and the determined at least one protocol specification.

According to an aspect of the present disclosure, there is provided a non-transitory computer-readable recording medium comprising instructions, wherein when executed by a processor, the instructions cause the processor to perform operations of acquiring a message related to a cloud application, acquiring a workflow for the cloud application based on the message, determining at least one protocol specification for implementing the workflow, determining executable code for the cloud application using the determined at least one protocol specification and the workflow, and provisioning the cloud application using the determined executable code.

It should be noted that the effects of the present disclosure are not limited to those described above, and other effects of the present disclosure will be apparent from the following description.

### BRIEF DESCRIPTION OF THE DRAWINGS

The above and other aspects and features of the present disclosure will become more apparent by describing exemplary embodiments thereof in detail with reference to the attached drawings, in which:

FIG. 1 is a diagram illustrating an environment in which a cloud service system is applied, according to an embodiment of the present disclosure;

FIG. 2 is a diagram illustrating the architecture of a cloud service system according to an embodiment of the present disclosure;

FIG. 3 is a diagram illustrating the internal structure of a standardized layer according to an embodiment of the present disclosure;

FIG. 4 is a diagram illustrating common and functional attributes extracted from a message according to an embodiment of the present disclosure;

FIG. 5 is a diagram illustrating the generation of a workflow, a protocol template, and a code template through an artificial intelligence (AI) engine according to an embodiment of the present disclosure;

FIG. 6 is a diagram illustrating the verification of protocol specifications and executable code through an AI engine according to an embodiment of the present disclosure;

FIG. 7 is a flowchart for explaining a cloud application provision method according to an embodiment of the present disclosure;

FIG. 8 is a detailed flowchart for explaining step S200 in FIG. 7 according to an embodiment of the present disclosure;

FIG. 9 is a diagram illustrating a workflow according to an embodiment of the present disclosure;

FIG. 10 is a detailed flowchart for explaining step S300 in FIG. 7 according to an embodiment of the present disclosure;

FIG. 11 is a detailed flowchart for explaining step S400 in FIG. 7 according to an embodiment of the present disclosure;

FIG. 12 is a diagram illustrating various protocol specifications according to an embodiment of the present disclosure;

FIG. 13 is a detailed flowchart for explaining step S500 in FIG. 7 according to an embodiment of the present disclosure;

FIG. 14 is a detailed flowchart for explaining step S600 in FIG. 7 according to an embodiment of the present disclosure;

FIG. 15 is a diagram illustrating executable code according to an embodiment of the present disclosure; and

FIG. 16 is a diagram illustrating the hardware configuration of a computing system according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Before describing embodiments of the present disclosure, the terms used herein will hereinafter be explained.

In the embodiments of the present disclosure, “infrastructure” refers to at least one of the hardware and software resources included in a cloud computing system.

In the embodiments of the present disclosure, a “cloud application” may be an application built using part of the infrastructure included in the cloud computing system. A user may pay a cloud service provider (CSP) for the cloud application and, during the agreed period, construct a virtual computer using one or more pieces of infrastructure to realize the cloud application. The user can then utilize the cloud application through the virtual computer.

In the embodiments of the present disclosure, a “protocol” may be the smallest unit for performing an individual function.

In the embodiments of the present disclosure, a “protocol template” refers to a form of a protocol for which detailed data (e.g., parameters) has yet to be applied.

In the embodiments of the present disclosure, a “protocol specification” refers to a protocol template with detailed parameters applied. For example, when a first protocol template is prepared to set the maximum bandwidth for downloads in a specific network, applying a maximum bandwidth parameter of 5 Mbps to the first protocol template is understood as a first protocol specification.

In the embodiments of the present disclosure, a “workflow” may include one or more tasks to be carried out to provide a cloud application. The workflow may include the sequence of the tasks, and a specific workflow may be defined based on the sequence and details of the tasks. Here, the term “task” may be a process that needs to be executed within the cloud computing system to provide the cloud application.

In the embodiments of the present disclosure, a “code template” may be understood as a form for multiple pieces of code used to process a specific workflow. In other words, a code template may be understood as a form of code that needs to be executed to process each task included in a workflow.

In the embodiments of the present disclosure, “provisioning” refers to preparing a cloud application for use by utilizing infrastructure to provide the cloud application. For example, if a cloud application requires a first capacity and a first processing speed, provisioning the cloud application may involve creating a virtual machine with the first capacity and the first processing speed to prepare the cloud application.

The following provides a detailed description of some embodiments of the present disclosure with reference to the accompanying drawings.

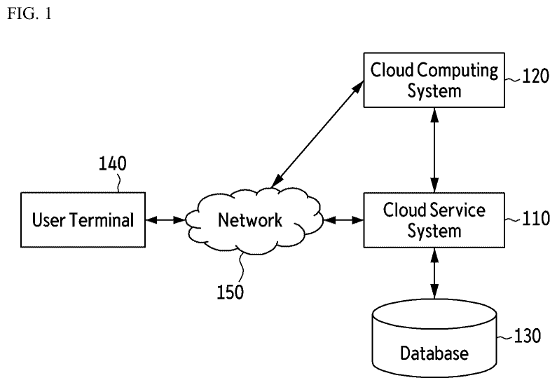

FIG. 1 is a diagram illustrating an environment in which a cloud service system is applied according to an embodiment of the present disclosure.

Referring to FIG. 1, a cloud service system 110 may communicate with a cloud computing system 120 and a user terminal 140. Additionally, the cloud service system 110 may access a database 130 to obtain a variety of data. The database 130 may include a dataset for training an artificial intelligence (AI) engine. Furthermore, the database 130 may contain subscriber information such as the name, date of birth, mobile phone number, and email address of a subscriber. The subscriber information may include details regarding a cloud application the subscriber is using. Additionally, the database 130 may store various types of information related to a cloud application. The information related to a cloud application may include the name of cloud application, the usage fee of the cloud application, and multiple pieces of infrastructure used to build the cloud application.

In one embodiment, the cloud service system 110 may provide a cloud console to the user terminal 140 and receive messages or configuration information from the user terminal 140 through the cloud console.

The cloud service system 110 may control the infrastructure included in the cloud computing system 120. Here, the cloud computing system 120 includes multiple pieces of infrastructure and may allocate one or more pieces of infrastructure related to a specific cloud application, under the control of the cloud service system 110. That is, the cloud computing system 120 may allocate one or more pieces of infrastructure for a user to provide the specific cloud application.

In one embodiment, the cloud service system 110 may acquire a message related to a cloud application and acquire a workflow for the cloud application based on the acquired message. The cloud service system 110 may then determine at least one protocol specification for realizing the acquired workflow. Additionally, the cloud computing system 120 may determine executable code for the cloud application by utilizing the determined at least one protocol specification and the acquired workflow and may provision the cloud application using the determined executable code. Here, the executable code may be program code for building the cloud application in the cloud computing system 120.

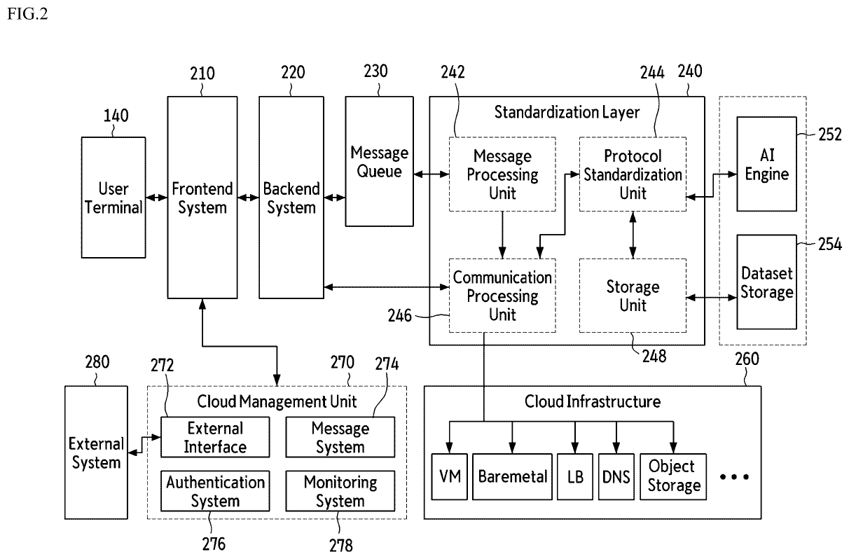

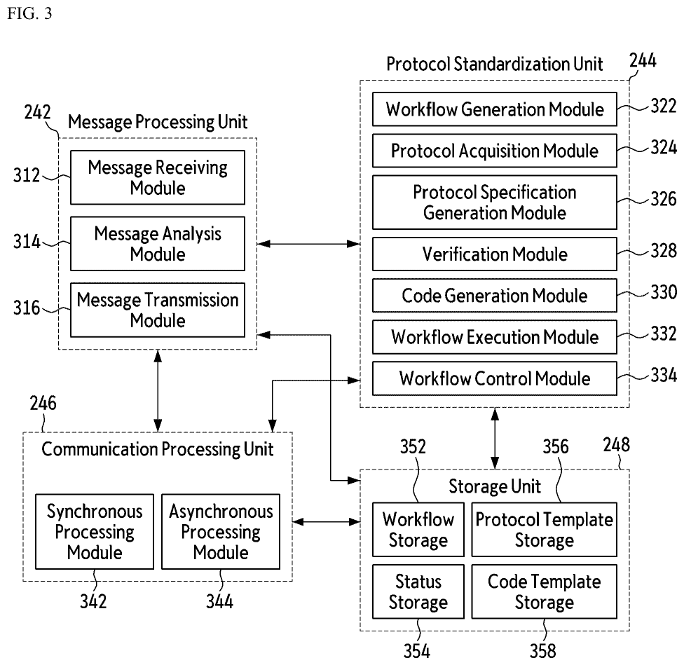

The internal configuration of the cloud service system 110 will hereinafter be described with reference to FIGS. 2 and 3.

FIG. 2 is a diagram illustrating the architecture of the cloud service system 110 according to an embodiment of the present disclosure.

FIG. 3 is a diagram illustrating the internal configuration of a standardization layer 240 according to an embodiment of the present disclosure.

A storage unit 248 disclosed in FIGS. 2 and 3 may be included in or include the database 130 of FIG. 1. Additionally, some of the components disclosed in FIG. 2 may be included in at least one of the cloud computing system 120 or the cloud service system 110.

Referring to FIGS. 2 and 3, the cloud service system 110 may include a frontend system 210, a backend system 220, a message queue 230, a standardization layer 240, an AI engine 252, a dataset storage 254, cloud infrastructure 260, and a cloud management unit 270.

The frontend system 210 may provide the user terminal 140 with a list of cloud applications and support the purchase of cloud applications. The frontend system 210 supports a user console and may provide the user terminal 140 with a user interface that enables for purchasing, modifying, and controlling a cloud application. Accordingly, the user terminal 140 may use the user interface to manage the lifecycle of a cloud application.

The backend system 220 may process functions such as provisioning, modification, deletion, and inquiry of a cloud application requested by a user through the user console. The backend system 220 may generate a message for controlling infrastructure. For example, the backend system 220 may generate a message for controlling infrastructure using a predefined format (i.e., a standard format). The message generated by the backend system 220 may be created based on user input received through the user console.

In some embodiments, when a synchronous message is received, the backend system 220 may convert the received message into a format (i.e., a standardized format) that can be processed by the standardization layer 240 and deliver the converted message to a synchronous processing module 342 of a communication processing unit 246. The synchronous message may be a message that needs to be processed in real time. For example, a query-related message may be a synchronous message.

Additionally, when an asynchronous message is received, the backend system 220 may convert the received message into the standardized format that can be processed by the standardization layer 240 and deliver the converted message to an asynchronous processing module 344 of the communication processing unit 246. Here, the standardized format may refer to a predefined format used in the present disclosure. An asynchronous message is a message that does not need to be processed in real time, and the standardized format for an asynchronous message may be divided into common and functional attributes. In one embodiment, the backend system 220 may generate a message having the standardized format based on user input information received from the user console.

The message queue 230 may be a storage area where messages generated by the backend system 220 are registered. Messages registered in the message queue 230 may be extracted by a message processing unit 242 in a first-in, first-out (FIFO) manner.

The message queue 230 may store asynchronous messages. Additionally, the message queue 230 may store messages related to processing results for asynchronous messages.

A message registered in the message queue 230 may be processed by a message reception module 312 of the message processing unit 242. When the processing of an asynchronous message is completed through the standardization layer 240, the processed message may be registered in the message queue 230. In this case, the backend system 220 may retrieve and process the message registered in the message queue 230.

The message processing unit 242 may perform functions such as receiving a message, analyzing the message, and transmitting processing results.

The message processing unit 242 may include the message reception module 312, a message analysis module 314, and a message transmission module 316.

The message reception module 312 may receive a message registered in the message queue 230 of the protocol standardization unit 244. The message reception module 312 may store the received message in the storage unit 248.

The message analysis module 314 may analyze a message and extract common and functional attributes from the message through parsing.

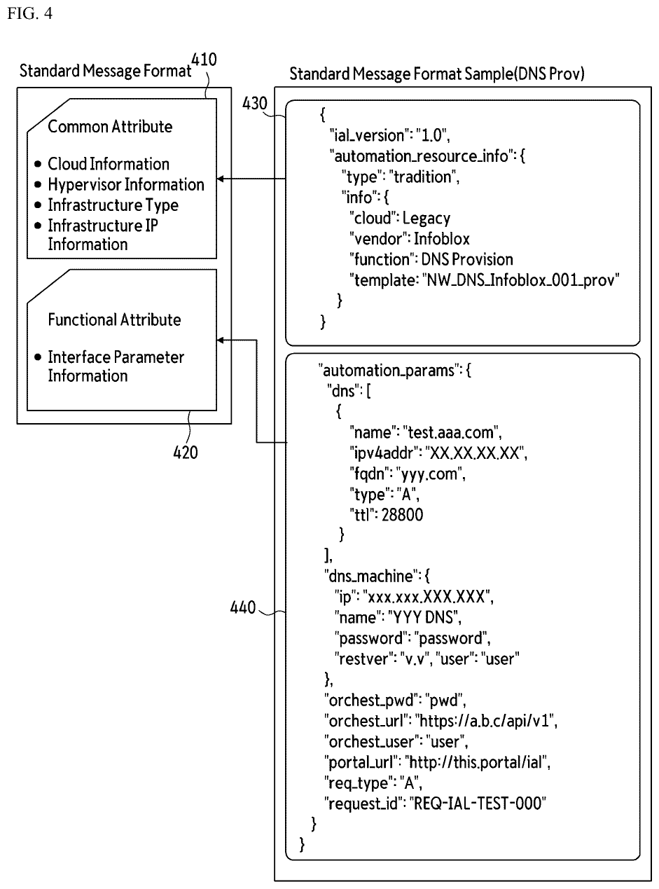

FIG. 4 is a diagram illustrating common and functional attributes 410 and 420 extracted from a message according to an embodiment of the present disclosure.

Referring to FIG. 4, the common and functional attributes 410 and 420 may be extracted from a message. The common attribute 410, which relate to the infrastructure used for a specific function, may include cloud information, hypervisor information, infrastructure type, infrastructure IP information, database type, or the like. Additionally, the functional attribute 420 may be parameter data for applying the specific function. That is, the message analysis module 314 may extract the common and functional attributes 410 and 420 from information contained in a message related to a cloud application. Furthermore, the common attribute 410 may refer to cloud infrastructure, including hardware and software, used to implement the cloud application, and the functional attribute 420 may refer to detailed parameters applied to the corresponding infrastructure.

In FIG. 4, an example is illustrated where the common attribute 410 is extracted from data included in a first area 430 of a standard message, and the functional attribute 420 is extracted from data included in a second area 440 of the standard message.

At least one of the common and functional attributes 410 and 420 extracted from the message may be used to determine a protocol, a protocol specification, or executable code.

A protocol template related to the common attribute 410 may be retrieved from a protocol template storage 356 of the storage unit 248.

If the protocol template related to the common attribute 410 is not found in the template storage 356, the protocol standardization unit 244 may query the AI engine 252 for a protocol template, obtain a protocol template, and determine the obtained protocol template as a protocol template for the cloud application. The protocol template obtained from the AI engine 252 may be associated with the common attribute 410 and stored in the protocol template storage 356.

The information analyzed by the message analysis module 314 may be delivered to the asynchronous processing module 344. In some embodiments, once the protocol template and protocol specification are determined, they may be stored in the storage unit 248 in association with an asynchronous message.

The message transmission module 316 may execute a workflow in the protocol standardization unit 244 and receive the result for a processed message through the asynchronous processing module 344. The received message and result may be converted into a format recognizable by the message queue 230 and registered in the message queue 230.

The communication processing unit 246 may process both synchronous and asynchronous messages. The communication processing unit 246 may include a synchronous processing module 342 and an asynchronous processing module 344.

The synchronous processing module 342 may receive a synchronous message from the backend system 220 and control the cloud infrastructure 260 based on the received synchronous message.

The asynchronous processing module 344 may receive and process an analyzed and processed message from the message analysis module 314. For example, the asynchronous processing module 344 may transmit an asynchronous message to a workflow generation module 322. Additionally, when processing the result for an asynchronous message processed by a workflow control module 334 are received, the asynchronous processing module 344 may send the processing result for the asynchronous message to the message queue 230 for storage.

The protocol standardization unit 244 may generate a workflow, process a protocol, execute a code template, and store information based on the result of the execution for the asynchronous processing module 344. In one embodiment, the protocol standardization unit 244 may generate a workflow using the AI engine 252 and verify a protocol specification and executable code related to the generated workflow.

The protocol standardization unit 244 may acquire a standardized workflow based on at least one of the common and functional attributes of a message and may obtain a protocol template, a protocol specification, a code template, and executable code necessary for executing the acquired workflow. Here, the protocol template, protocol specification, code template, and executable code may each have a predefined format according to the present disclosure.

The protocol standardization unit 244 may include the workflow generation module 322, a protocol acquisition module 324, a protocol specification writing module 326, a verification module 328, a code generation module 330, a workflow execution module 332, and a workflow control module 334.

The workflow generation module 322 may generate a workflow based on the common attribute of a message. In one embodiment, the workflow generation module 322 may determine whether there exists a workflow related to the extracted common attribute in a workflow storage 352 of the storage unit 248. Then, if the workflow related to the extracted common attribute is found, the workflow generation module 322 may extract the workflow from the workflow storage 352. Conversely, if no related workflow is found, the workflow generation module 322 may input the extracted common attribute into the AI engine 252 to generate a workflow using the AI engine 252. The workflow generation module 322 may store the workflow generated through the AI engine 252 in the workflow storage 352 together with the extracted common attribute.

The protocol acquisition module 324 may obtain a protocol template for processing each detailed function related to the functional attribute of a message. In one embodiment, if an asynchronous message that has not been previously managed, has no processing history, or cannot be analyzed is obtained, the protocol acquisition module 324 may use the AI engine 252 to obtain a protocol template. For example, if a protocol template related to the common and functional attributes of an asynchronous message is not found in the protocol template storage 356 of the storage unit 248, the protocol acquisition module 324 may generate a protocol template related to the common and functional attributes of the asynchronous message using the AI engine 252. The protocol template generated through the AI engine 252 may be stored in the protocol template storage 356 together with the common and functional attributes of the asynchronous message.

The protocol specification writing module 326 may write a protocol specification by applying detailed data (e.g., parameters) to a protocol template. That is, the protocol specification writing module 326 may write a protocol specification by applying parameters to a protocol template obtained by the protocol acquisition module 324. The protocol specification writing module 326 may extract parameters from a message and apply the extracted parameters to the protocol template.

Once the protocol specification is written, the verification module 328 may verify the validity of the protocol specification by querying the AI engine 252. If the verification of the protocol specification fails, the verification module 328 may request the protocol specification writing module 326 to rewrite the protocol specification.

The code generation module 330 may obtain a code template for executing a workflow and generate executable code using the obtained code template and the protocol specification. In one embodiment, the code generation module 330 may first check whether a code template related to the protocol specification and workflow is stored in a code template storage 358 of the storage unit 248. If no related code template is stored, the code generation module 330 may obtain a code template related to the protocol specification and workflow using the AI engine 252. The code generation module 330 may apply the protocol specification to the obtained code template to generate executable code for executing the workflow. Here, multiple protocol specifications may be applied to a code template.

In one embodiment, once the executable code is generated or written, the verification module 328 may verify the validity of the executable code by querying the AI engine 252. If the verification of the executable code fails, the verification module 328 may request the code generation module 330 to rewrite the executable code.

The workflow execution module 332 may execute an operation related to the workflow in the cloud computing system 120 based on the generated executable code.

The workflow control module 334 may monitor the operational state of a workflow related to the executable code and store the result of the monitoring in a status storage 354 of the storage unit 248. In one embodiment, the workflow control module 334 may store training data including a workflow, a protocol template, a protocol specification, a code template, and the common and functional attributes of a message, in the dataset storage 254.

The storage unit 248, which is means for storing various data, may include the workflow storage 352, the protocol template storage 356, the status storage 354, and the code template storage 358.

The workflow storage 352 may store a plurality of workflows related to different common attributes.

The protocol template storage 356 may store a plurality of protocol templates related to common and functional attributes. Here, the plurality of protocol templates may differ in at least one of the common and functional attributes.

The code template storage 358 may store a plurality of code templates related to workflows and protocol specifications. Here, the plurality of code templates may differ in at least one of the workflows or protocol specifications.

The status storage 354 may store a plurality of messages. Additionally, the status storage 354 may store processing status information and processing result data from the protocol standardization unit 244.

The cloud infrastructure 260 may include hardware, software, and the like. As illustrated in FIG. 2, the cloud infrastructure 260 may include virtual machines (VMs), bare-metal servers, load balancers (LBs), domain name systems (DNS), object storages, operating systems, and database management systems.

The cloud management unit 270 may function to stably provide a cloud service. The cloud management unit 270 may include an external interface 272 for communication with an external system 280, a message system 274 for processing messages, an authentication system 276 for subscriber authentication, and a monitoring system 278 for monitoring cloud status.

The dataset storage 248 may store a plurality of training data used for training the AI engine 252. Based on the training data, the AI engine 252 may be subject to training and fine-tuning. The dataset storage 248 may store training data that includes at least one of workflows, protocol templates, protocol specifications, code templates, or the common attributes and functional attributes of messages.

The AI engine 252 may be implemented as hardware, software, or a combination thereof and may include one or more AI models. In one embodiment, the AI engine 252 may include a language model capable of processing natural language. For example, the AI engine 252 may include a natural language processing model such as Large Language Model (LLM), Bidirectional Encoder Representations from Transformers (BERT), and Generative Pre-trained Transformer (GPT). The AI engine 252 may be trained through supervised or semi-supervised learning to analyze text expressed in natural language, infer a user request, and output the result corresponding to the inferred user request. Here, the text input into the AI engine 252 may also be referred to as a prompt. Additionally, the AI engine 252 may generate data and perform validation of input data.

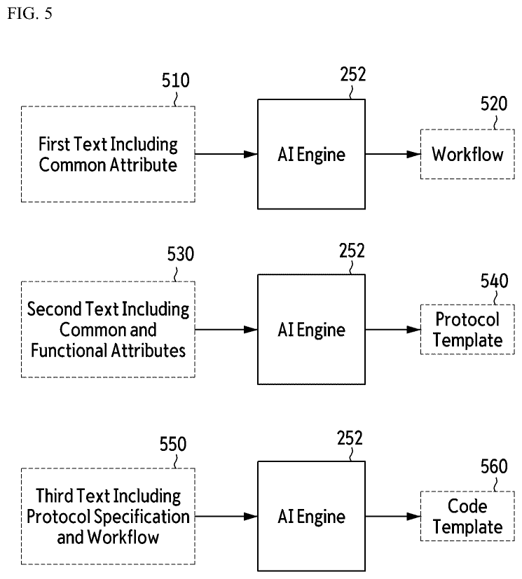

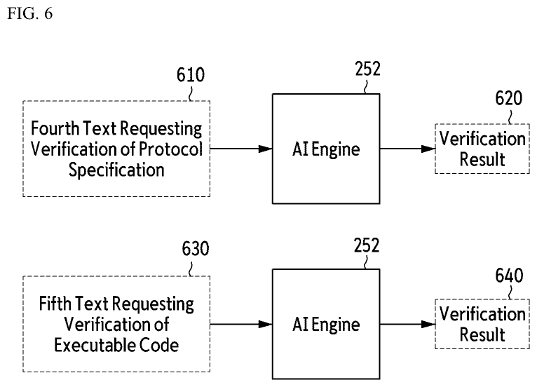

It will hereinafter be described how to generate and verify various data using the AI engine 252 with reference to FIGS. 5 and 6.

FIG. 5 is a diagram illustrating the generation of a workflow, a protocol template, and a code template through the AI engine 252, according to an embodiment of the present disclosure.

Referring to FIG. 5, first text 510, which includes the common attribute of a message and requests the generation of a workflow, may be input into the AI engine 252. For example, first text 510 that reads, “Generate a workflow based on the common attribute,” may be input into the AI engine 252. Here, the first text 510 may contain text associated with the common attribute. In this case, the AI engine 252 may output a workflow 520 related to common attribute. To ensure the output of a workflow 520 with high accuracy, the AI engine 252 may be pre-trained using a training dataset that includes common attributes extracted from equipment user manuals, equipment specifications, and predefined common attributes provided by various infrastructure manufacturers.

Additionally, second text 530, which includes both the common and functional attributes of a message and requests the generation of a protocol template, may be input into the AI engine 252. For example, second text 530 that reads, “Generate a protocol template based on the common and functional attributes,” may be input into the AI engine 252. The second text 530 may contain both text referring to the common attribute and text referring to the functional attribute. In this case, the AI engine 252 may output a protocol template 540 related to both the common and functional attributes. To ensure the output of a protocol template 540 with high accuracy, the AI engine 252 may be pre-trained using a training dataset that includes common attributes and functional attributes extracted from equipment user manuals, equipment specifications, and predefined attributes provided by various infrastructure manufacturers.

Furthermore, third text 550, which includes a protocol specification and workflow and requests the generation of a code template, may be input into the AI engine 252. For example, third text 550 may be “Generate a code template based on the protocol specification and workflow.” The third text 550 may contain both text referring to the protocol specification and text referring to the workflow. In this case, the AI engine 252 may output a code template 560 related to both the protocol specification and workflow. To ensure the output of a code template with high accuracy, the AI engine 252 may be pre-trained using a training dataset that includes protocol specifications, workflows, and predefined attributes extracted from equipment user manuals, equipment specifications, and predefined data provided by various infrastructure manufacturers.

According to some embodiments, the text input into the AI engine 252 may be automatically generated by the protocol standardization unit 244. For example, the first text 510, second text 530, and third text 550 illustrated in FIG. 5 may be automatically generated by the protocol standardization unit 244 and then input into the AI engine 252.

FIG. 6 is a diagram illustrating the verification of a protocol specification and executable code through the AI engine 252 according to an embodiment of the present disclosure.

Referring to FIG. 6, fourth text 610 requesting verification of a protocol specification may be input into the AI engine 252. For example, fourth text 610 that reads, “Verify the attached protocol specification,” may be input into the AI engine 252. In this case, the AI engine 252 may verify the protocol specification for error and output a verification result 620. To improve verification accuracy, the AI engine 252 may be pre-trained to analyze multiple protocol specifications and output verification results accordingly.

Additionally, fifth text 630 requesting verification of executable code may be input into the AI engine 252. For example, fifth text 630 that reads, “Verify the attached executable code,” may be input into the AI engine 252 along with a file specifying the executable code. In this case, the AI engine 252 may verify the executable code for error and output a verification result 640. To improve verification accuracy, the AI engine 252 may be pre-trained to analyze multiple code specifications and output verification results accordingly.

According to some embodiments, the text related to a verification request input into the AI engine 252 may be automatically generated by the protocol standardization unit 244. For example, the fourth text 610 and fifth text 630 illustrated in FIG. 6 may be automatically generated by the protocol standardization unit 244 and then input into the AI engine 252.

The aforementioned AI engine 252 may include an artificial neural network model. In one embodiment, the artificial neural network model, which is an example of an AI model, may be a statistical learning algorithm or a structure that executes such an algorithm, implemented based on the structure of a biological neural network, in the fields of machine learning and cognitive science. In one embodiment, the artificial neural network model may comprise artificial neurons, referred to as nodes, which form a network through synaptic connections, similar to a biological neural network. These nodes adjust their synaptic weights iteratively to reduce the error between a specific input and the correct or inferred output, thereby functioning as a machine learning model capable of problem-solving. For example, the artificial neural network model may include a probabilistic model, a neural network model, or the like used in the field of AI learning such as machine learning and deep learning.

The artificial neural network model may be implemented as a multilayer perceptron (MLP) consisting of multiple layers of nodes and their connections. The artificial neural network model may be implemented using one of various artificial neural network structures that include an MLP. The artificial neural network model may include an input layer for receiving input signals or data from an external source, an output layer for outputting signals or data corresponding to the input data, and n hidden layers (where n is a positive integer) located between the input and output layers, for receiving signals from the input layer, extracting features from the received signals, and transmitting the extracted features to the output layer.

In the artificial neural network model, a plurality of input variables and a plurality of output variables respectively corresponding to the plurality of input variables may be matched at the input and output layers, respectively. By adjusting the synaptic weights between nodes included in the input, hidden, and output layers, the artificial neural network model can be trained to extract a correct output corresponding to a specific input. When the artificial neural network model is iteratively trained based on data included in a training dataset, the synaptic weights (or weights) between the nodes are adjusted to reduce the error between output variables calculated from the input variables and target outputs, eventually converging to optimal values.

According to some embodiments, the AI engine 252 may include a plurality of pre-trained AI models. For example, the AI engine 252 may include: a first AI model for generating the workflow 520; a second AI model for generating the protocol template 540; a third AI model for generating the code template 560; a fourth AI model for verifying a protocol specification; and a fifth AI model for verifying executable code. In another example, the AI engine 252 may include a sixth AI model for generating one of the workflow 520, protocol template 540, or code template 560 based on the intent of the request included in the input text. That is, depending on the input text, the sixth AI model may output one of the workflow 520, protocol template 540, or code template 560.

The AI engine 252 may include a seventh AI model for verifying at least one of a protocol specification or executable code based on the intent of the request included in the input text. That is, if a request to verify a protocol specification is input into the seventh AI model included in the AI engine 252, the seventh AI model may output the result of the verification of the protocol specification. Similarly, if a request to verify executable code is input, the seventh AI model may output the result of the verification of the executable code.

According to the present embodiment, even if new infrastructure is added to the cloud computing system 120, executable code for controlling the new infrastructure may be conveniently generated based on at least one of the workflow 520, protocol template 540, or code template 560 obtained from the AI engine 252. Accordingly, the need for manual development of protocols and executable code to control new infrastructure is eliminated, reducing the administrative workload. Furthermore, according to embodiments of the present disclosure, executable code with broad applicability may be generated, allowing it to be used across various infrastructure.

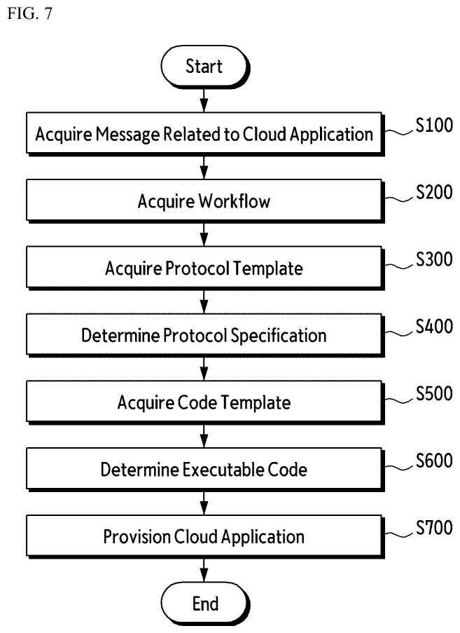

A cloud application provisioning method according to an embodiment of the present disclosure will hereinafter be described with reference to FIGS. 7 through 15.

FIG. 7 is a flowchart for explaining a cloud application provisioning method according to an embodiment of the present disclosure. The cloud application provisioning method according to an embodiment of the present disclosure is merely an example for achieving the objectives of the present disclosure, and some steps may be added or omitted as needed. Additionally, the cloud application provisioning according to an embodiment of the present disclosure may be performed by at least one processor included in a computing system. For convenience, the steps of the cloud application provisioning according to an embodiment of the present disclosure will be described as being performed by the cloud service system 110 in FIG. 1.

Referring to FIG. 7, the cloud service system 110 may obtain a message related to a cloud application (S100). Here, the acquired message may be a standardized asynchronous message generated through the backend system 220 based on user input acquired through a user console.

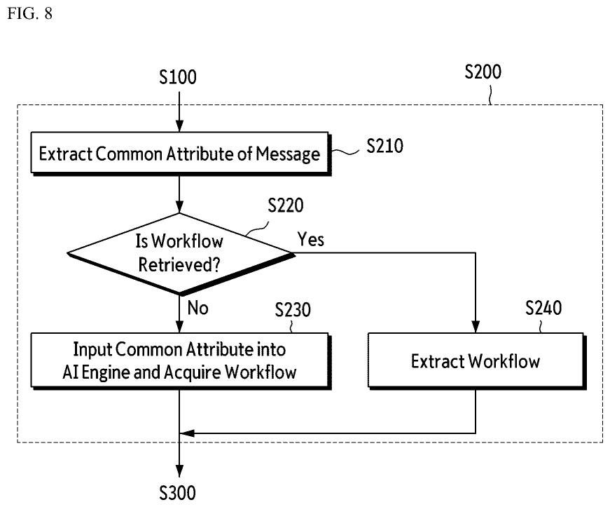

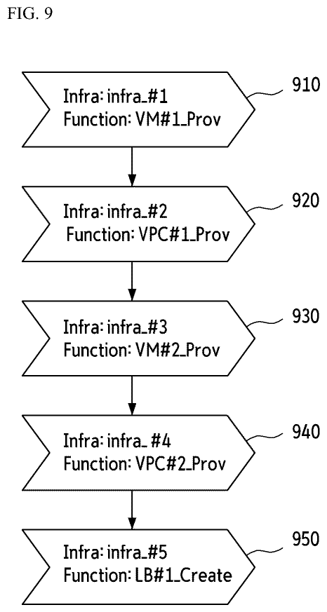

Thereafter, the cloud service system 110 may acquire a workflow for the cloud application based on the acquired message (S200). A detailed description of workflow acquisition will be provided later with reference to FIGS. 8 and 9.

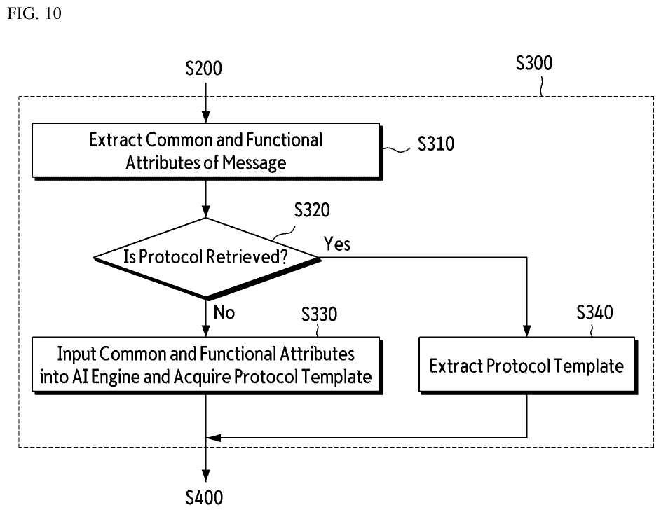

Thereafter, the cloud service system 110 may acquire a protocol template used to configure the acquired workflow (S300). A detailed description of protocol template acquisition will be provided later with reference to FIG. 10.

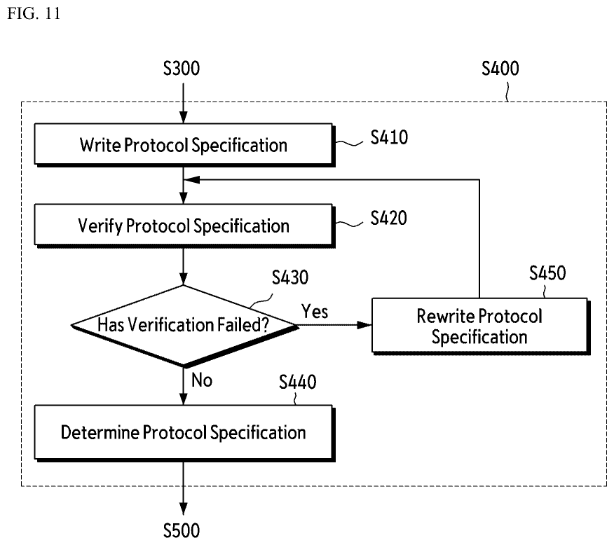

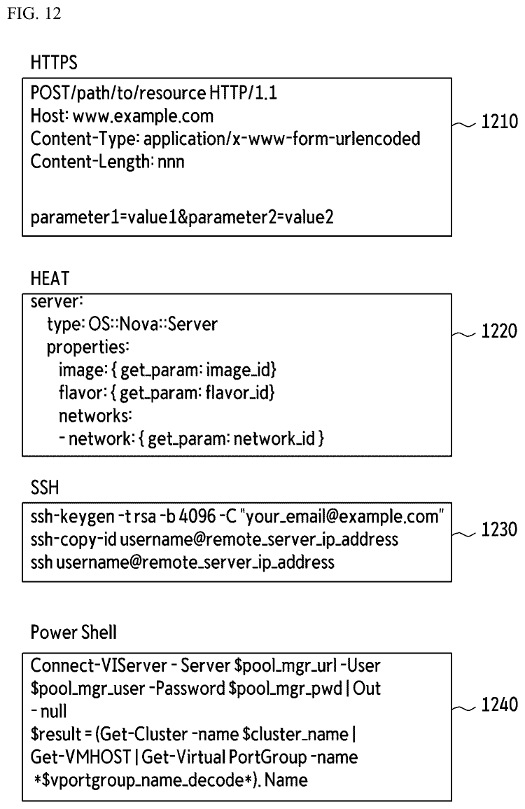

Thereafter, using the acquired protocol template, the cloud service system 110 may determine at least one protocol specification to configure the acquired workflow (S400). In one embodiment, the cloud service system 110 may identify a plurality of task procedures included in the acquired workflow and determine at least one protocol specification for each of the task procedures. In this case, the cloud service system 110 may acquire a protocol template for each of the task procedures and determine at least one protocol specification for each of the task procedures using the acquired protocol templates. A detailed description of the determination of a protocol specification will be provided later with reference to FIGS. 11 and 12.

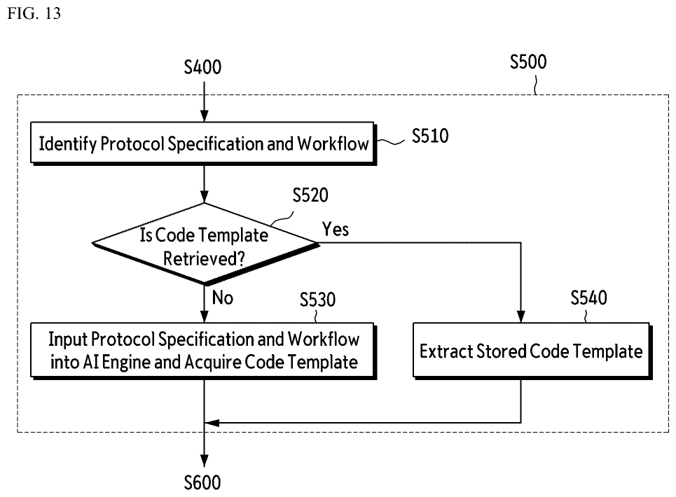

Thereafter, the cloud service system 110 may acquire a code template based on the determined at least one protocol specification and the acquired workflow (S500). A detailed description of code template acquisition will be provided later with reference to FIG. 13.

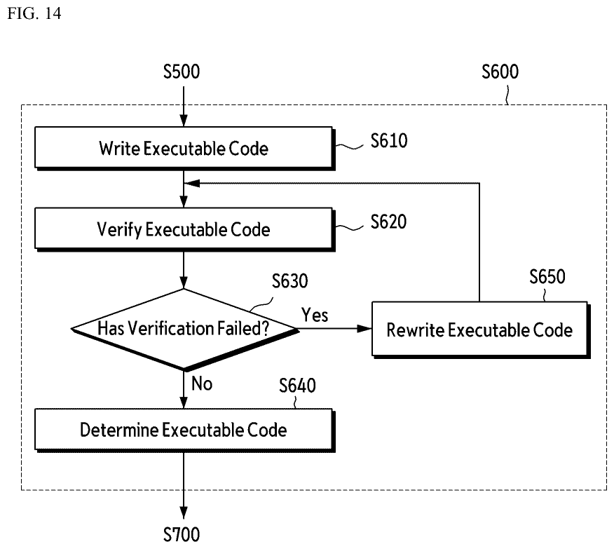

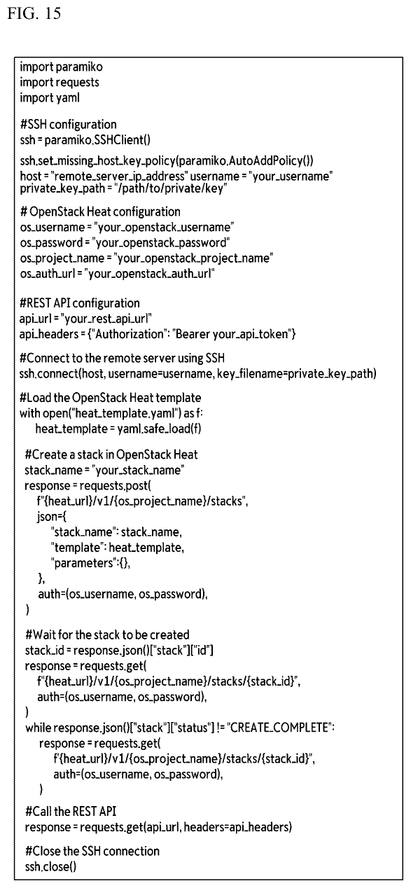

Thereafter, the cloud service system 110 may determine executable code for the cloud application based on the acquired code template and at least one protocol specification (S600). A detailed description of the determination of executable code will be provided later with reference to FIGS. 14 and 15.

Thereafter, the cloud service system may provision the cloud application using the determined executable code (S700).

According to the present embodiment, executable code capable of controlling various infrastructure may be automatically generated.

FIG. 8 is a detailed flowchart for explaining step S200 in FIG. 7 according to an embodiment of the present disclosure. The embodiment of FIG. 8, as well as the embodiments of FIGS. 11, 13, and 14 that will be described later, may be performed by the protocol standardization unit 244 in FIG. 3.

Referring to FIG. 8, the cloud service system may extract the common attribute of the message (S210).

Thereafter, the cloud service system may determine whether a workflow related to the extracted common attributes exists (S310). That is, the cloud service system may determine whether a workflow related to the extracted common attribute has already been stored.

Thereafter, if it is determined that no workflow related to the extracted common attribute exists, the cloud service system may input the common attribute into the AI engine 252 and acquire a workflow from the AI engine 252 (S230). For example, first text may be automatically generated to request the generation of a workflow based on the extracted common attribute, and may then be input into the AI engine 252.

Conversely, if it is determined that a workflow related to the extracted common attribute exists, the cloud service system may extract the workflow related to the extracted common attribute from among the plurality of workflows stored in the workflow storage 352 (S240).

FIG. 9 is a diagram illustrating a workflow according to an embodiment of the present disclosure.

Referring to FIG. 9, a workflow may comprise a plurality of first, second, third, fourth, and fifth tasks 910, 920, 930, 940, and 950 arranged in sequence. Each of the first, second, third, fourth, and fifth tasks 910, 920, 930, 940, and 950 may include infrastructure and functionality. For example, the first task 910, which needs to be executed first to implement the workflow, may include functionality related to first infrastructure infra_#1 and a first virtual machine VM #1.

FIG. 10 is a detailed flowchart for explaining step S300 in FIG. 7 according to an embodiment of the present disclosure.

Referring to FIG. 10, the cloud service system may extract the common and functional attributes of the message (S310).

Then, the cloud service system may determine whether a protocol template related to the extracted common and functional attributes exists (S320). That is, the cloud service system may determine whether a protocol template related to the extracted common and functional attributes has already been stored.

Thereafter, if it is determined that no protocol template related to the extracted common and functional attributes exists, the cloud service system may input the extracted common and functional attributes into the AI engine 252 and acquire a protocol template from the AI engine 252 (S330). For example, second text may be automatically generated to request the generation of a protocol template based on the extracted common and functional attributes, and may then be input into the AI engine 252.

Conversely, if it is determined that a protocol template related to the extracted common and functional attributes exists, the cloud service system may extract the protocol template related to the extracted common and functional attributes from among the plurality of protocol templates stored in the template storage 356 (S340).

FIG. 11 is a detailed flowchart for explaining step S400 in FIG. 7 according to an embodiment of the present disclosure. The embodiment of FIG. 11 relates to a method for acquiring a protocol specification. If multiple protocol specifications need to be acquired, the embodiment of FIG. 11 may be performed for each protocol specification.

Referring to FIG. 11, the cloud service system 110 may write a protocol specification based on the functional attribute of the message and the protocol template (S410). For example, the cloud service system 110 may extract parameters from the functional attribute and apply the extracted parameters to parameters that have not yet been applied in the protocol template, thereby writing a protocol specification.

Thereafter, the cloud service system 110 may verify the generated protocol specification using the AI engine 252 (S420). For example, the cloud service system 110 may input third text requesting verification of the protocol specification into the AI engine 252 and receive the result of the verification from the AI engine 252.

The cloud service system 110 may determine whether the verification result indicates success or failure (S430). If the verification of the protocol specification fails, the cloud service system 110 may rewrite the protocol specification (S450). For example, if common and functional attributes are input into the AI engine 252, the AI engine 252 may output multiple protocol templates. In this case, the cloud service system 110 may write a first protocol specification using a first protocol template and the input functional attribute, and perform verification of the first protocol specification using the AI engine 252. If the verification of the first protocol specification fails, the cloud service system 110 may write a second protocol specification using a second protocol template and the input functional attribute and perform verification of the second protocol specification using the AI engine 252.

In some embodiments, if the verification of the protocol specification fails, the AI engine 252 may output detailed information on error in the protocol specification. The verification result may include details regarding the error. That is, the AI engine 252 may infer the cause of the error in the protocol specification and output the inferred cause. In this case, the cloud service system may rewrite the protocol specification by modifying detailed data related to the cause of the error.

Thereafter, the cloud service system 110 may repeat step S420 to verify the rewritten protocol specification.

Conversely, if it is determined in step S430 that the verification of the protocol specification has succeeded, the cloud service system 110 may determine the protocol specification as a protocol specification to be used for generating executable code (S440). For example, if the verification of the first protocol specification fails, the cloud service system may write the second protocol specification. If the verification of the second protocol specification succeeds, the cloud service system 110 may determine the second protocol specification as the protocol specification to be used for configuring the executable code. In this case, the AI engine 252 may output a verification failure result for the first protocol specification and a verification success result for the second protocol specification.

FIG. 12 is a diagram illustrating various protocol specifications according to an embodiment of the present disclosure.

Referring to FIG. 12, a first protocol specification 1210 is an exemplary protocol specification related to HTTPS, and a second protocol specification 1220 is an exemplary protocol specification related to Highly Evasive Adaptive Threats (HEAT). Additionally, a third protocol specification 1230 is an exemplary protocol specification related to Secure Shell (SSH), and a fourth protocol specification 1240 is an exemplary protocol specification related to PowerShell.

According to the present embodiment, since each protocol specification is verified in advance, any error that may occur during the provisioning of a cloud application can be minimized.

FIG. 13 is a detailed flowchart for explaining step S500 in FIG. 7 according to an embodiment of the present disclosure.

Referring to FIG. 13, the cloud service system 110 may identify the determined at least one protocol specification and the acquired workflow (S510).

Thereafter, the cloud service system 110 may determine whether a code template related to the identified protocol specification and workflow exists (S520). That is, the cloud service system may determine whether a code template related to the identified protocol specification and workflow has already been stored.

Thereafter, if it is determined that no code template related to the identified protocol specification and workflow exists, the cloud service system 110 may input the identified protocol specification and workflow into the AI engine 252 and acquire a code template from the AI engine 252 (S530). For example, fifth text requesting the generation of a code template based on the identified protocol specification and workflow may be automatically generated and input into the AI engine 252.

Conversely, if it is determined that a code template related to the identified protocol specification and workflow exists, the cloud service system 110 may extract the code template from among the plurality of code templates stored in the template storage 356 (S540).

FIG. 14 is a detailed flowchart for explaining step S600 in FIG. 7 according to an embodiment of the present disclosure.

Referring to FIG. 14, the cloud service system 110 may write executable code based on the acquired code template and the determined at least one protocol specification (S610). For example, the cloud service system 110 may apply the determined at least one protocol specification to the acquired code template, thereby writing executable code.

Thereafter, the cloud service system 110 may verify the executable code using the AI engine 252 (S620). For example, the cloud service system 110 may input sixth text requesting verification of the executable code into the AI engine 252 and receive the result of the verification from the AI engine 252.

The cloud service system 110 may determine whether the verification result indicates success or failure (S630). If the verification of the executable code fails, the cloud service system 110 may rewrite the executable code (S650). For example, in response to one or more protocol specifications and a workflow being input into the AI engine 252, the AI engine 252 may output multiple code templates. In this case, the cloud service system 110 may generate first executable code using a first code template and the input protocol specifications, and perform verification of the first executable code using the AI engine 252. If the verification of the first executable code fails, the cloud service system 110 may generate second executable code using a second code template and the input protocol specifications and perform verification of the second executable code using the AI engine 252.

In some embodiments, if the verification of executable code fails, the AI engine 252 may output detailed information on error in the executable code. That is, the AI engine 252 may infer the cause of the error in the executable code and output the inferred cause. In this case, the cloud service system 110 may rewrite the executable code by modifying detailed data related to the cause of the error.

Thereafter, the cloud service system 110 may repeat step S620 to verify the rewritten executable code.

Conversely, if it is determined in step S630 that the verification of the executable code has succeeded, the cloud service system 110 may determine the executable code as executable code for provisioning the cloud application (S640). For example, if the verification of the first executable code fails, the cloud service system may generate the second executable code. If the verification of the second executable code succeeds, the cloud service system 110 may determine the second executable code as the executable code for provisioning the cloud application. In this case, the AI engine 252 may output a verification failure result for the first executable code and a verification success result for the second executable code.

FIG. 15 is a diagram illustrating executable code according to an embodiment of the present disclosure. FIG. 15 shows exemplary executable code including multiple protocol specifications related to SSH, HEAT, and the like.

According to the present embodiment, the use of verified executable code allows for the provisioning of the cloud application with minimal execution error, thereby enhancing customer satisfaction.

If the provisioning of the cloud application is successfully completed, the cloud service system 110 may generate and store training data including at least one of the provisioning-related workflow, protocol specification, or executable code, or the common and functional attributes extracted from the message. For example, the generated training data may be stored in the dataset storage 254 in FIG. 2.

Based on the stored training data, the AI engine 252 may be retrained and fine-tuned. As the AI engine 252 is fine-tuned, the accuracy of the results output by the AI engine 252 may be enhanced. For example, at least one of the workflow, protocol specification, and executable code included in the stored training data may be used as ground truth data for training the AI engine 252.

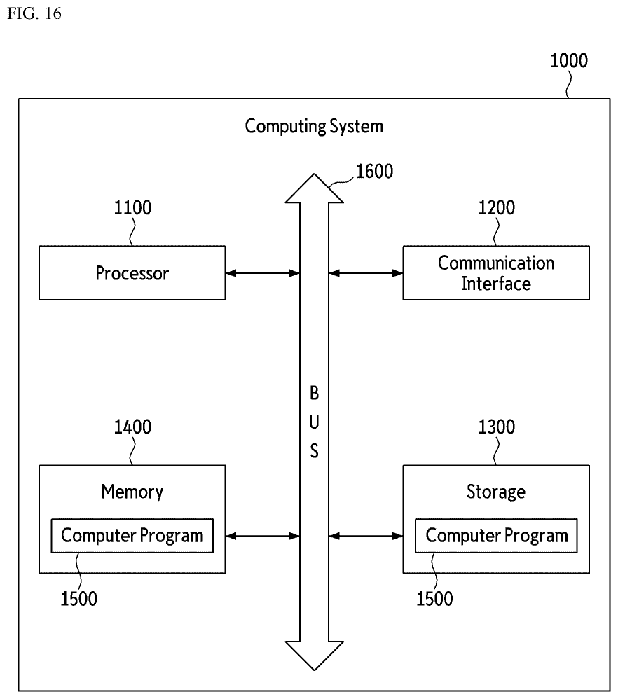

FIG. 16 is a hardware configuration view of an exemplary computing system 1000 according to some embodiments of the present disclosure. The computing system 1000 may include at least one processor 1100, a bus 1600, a communication interface 1200, a memory 1400, which loads a computer program 1500 to be executed by the processor 1100, and a storage 1300, which stores the computer program 1500.

The computing system 1000 of FIG. 16 may present a hardware structure of a computing system that constitutes the cloud service system 110 described with reference to FIG. 1.

The processor 1100 may control the overall operations of the components of the computing system 100. The processor 1100 may perform operations related to at least one application or program to execute operations/methods according to various embodiments of the present disclosure. The memory 1400 may store various data, commands, and/or information. The memory 1400 may load the computer program 1500 from the storage 1300 to execute the operations/methods according to various embodiments of the present disclosure. The storage 1300 may non-transitorily store at least one computer program 1500.

The computer program 1500 may include one or more instructions that enable the processor 1100 to perform the operations/methods according to various embodiments of the present disclosure when loaded into the memory 1400. In other words, by executing the loaded instructions, the processor 1100 may perform the operations/methods according to various embodiments of the present disclosure.

According to one embodiment, the computer program 1500 may include instructions for operations of acquiring a message related to a cloud application, acquiring a workflow for the cloud application based on the message, determining at least one protocol specification for implementing the workflow, determining executable code for the cloud application using the determined at least one protocol specification and the workflow and provisioning the cloud application using the determined executable code.

In some embodiments, the computing system 1000 as described with reference to FIG. 16 may be configured using one or more physical servers included in a server farm based on cloud technology such as virtual machines. In this case, at least some of the components as illustrated in FIG. 16, such as the processor 1100, the memory 1400, and the storage 1300 may be virtual hardware, and the communication interface 1200 may also be embodied as a virtualized networking element such as a virtual switch.

So far, a variety of embodiments of the present disclosure and the effects according to embodiments thereof have been mentioned with reference to FIGS. 1 to 16. The effects according to the technical idea of the present disclosure are not limited to the forementioned effects, and other unmentioned effects may be clearly understood by those skilled in the art from the description of the specification.

The methods according to the embodiments of the present disclosure described above may be performed by executing a computer program implemented using a computer-readable code. The computer program may be transmitted from a first computing device to a second computing device via a network such as the Internet and installed on the second computing device, and may be used by the second computing device. Furthermore, although the operations are illustrated in a specific order in the drawings, it should not be understood that the operations should be executed in the specific order as illustrated or in a sequential order or that all illustrated operations should be executed to acquire a desired result. In certain situations, multitasking and parallel processing may be advantageous.

Although some embodiments of the present disclosure have been described above with reference to the accompanying drawings, the present disclosure may not be limited to some embodiments and may be implemented in various different forms. Those of ordinary skill in the technical field to which the present disclosure belongs will be able to appreciate that the present disclosure may be implemented in other specific forms without changing the technical idea or essential features of the present disclosure. Therefore, it should be understood that some embodiments as described above are not restrictive but illustrative in all respects.

What is claimed is:

1. A cloud application provisioning method performed by a computing system, the cloud application provisioning method comprising:
acquiring a message related to a cloud application;
acquiring a workflow for the cloud application based on the message;
determining at least one protocol specification for implementing the workflow;
determining executable code for the cloud application using the determined at least one protocol specification and the workflow; and
provisioning the cloud application using the determined executable code.

2. The cloud application provisioning method of claim 1, wherein the acquiring the workflow comprises: extracting a common attribute for the cloud application from the message; and acquiring the workflow for the cloud application based on the extracted common attribute.

3. The cloud application provisioning method of claim 2, wherein the acquiring the workflow comprises: inputting the extracted common attribute into an artificial intelligence (AI) engine and acquiring the workflow from the AI engine.

4. The cloud application provisioning method of claim 3, wherein if it is determined that a workflow related to the extracted common attribute is not found in a database, the extracted common attribute is input into the AI engine.

5. The cloud application provisioning method of claim 1, wherein the determining the at least one protocol specification comprises: extracting a common feature and a functional attribute for the cloud application from the message; acquiring at least one protocol template for the cloud application based on the extracted common and functional attributes; and determining the at least one protocol specification using the at least one protocol template and the extracted functional attribute.

6. The cloud application provisioning method of claim 5, wherein the acquiring the at least one protocol template comprises: inputting the extracted common and functional attributes into an AI engine and acquiring the at least one protocol template from the AI engine.

7. The cloud application provisioning method of claim 6, wherein if it is determined that a protocol related to the extracted common and functional attributes is not found in a database, the extracted common and functional attributes are input into the AI engine.

8. The cloud application provisioning method of claim 1, wherein the determining the at least one protocol specification comprises: writing a first protocol specification; if verification of the first protocol specification fails, writing a second protocol specification; and determining the second protocol specification as a protocol specification for implementing the workflow in response to verification of the second protocol specification being successful.

9. The cloud application provisioning method of claim 8, wherein
first text requesting verification of the first protocol specification is input into an AI engine, and
the AI engine outputs a verification failure result for the first protocol specification, and outputs a verification success result for the second protocol specification upon receiving second text requesting verification of the second protocol specification.

10. The cloud application provisioning method of claim 1, wherein the determining the executable code for the cloud application comprises: acquiring a code template using at least one of the determined at least one protocol specification or the workflow; and determining the executable code for the cloud application based on the code template and the determined at least one protocol specification.

11. The cloud application provisioning method of claim 10, wherein the acquiring the code template comprises inputting the determined at least one protocol specification and the workflow into an AI engine and acquiring the code template from the AI engine.

12. The cloud application provisioning method of claim 1, wherein the determining the executable code for the cloud application comprises: writing first executable code using the determined at least one protocol specification and the workflow; if verification of the first executable code fails, writing second executable code using the determined at least one protocol specification and the workflow; and determining the second executable code as executable code for the cloud application in response to verification of the second executable code being successful.

13. The cloud application provisioning method of claim 12, wherein
third text requesting verification of the first executable code is input into an AI engine, and
the AI engine outputs a verification failure result for the first executable code, and outputs a verification success result for the second executable code upon receiving fourth text requesting verification of the second executable code.

14. The cloud application provisioning method of claim 1, wherein the determining the at least one protocol specification comprises: identifying a plurality of task procedures included in the workflow; and determining at least one protocol specification for each of the plurality of task procedures.

15. The cloud application provisioning method of claim 1, further comprising:
after the provisioning the cloud application, storing training data including at least one of the workflow, a protocol specification, the executable code, or common and functional attributes extracted from the message,
wherein the stored training data is used to fine-tune an AI engine.

16. A computing system comprising:
at least one processor; and
a memory storing a computer program executed by the at least one processor,
wherein the computer program comprises instructions for operations of: acquiring a message related to a cloud application; acquiring a workflow for the cloud application based on the message; determining at least one protocol specification for implementing the workflow; determining executable code for the cloud application using the determined at least one protocol specification and the workflow; and provisioning the cloud application using the determined executable code.

17. The computing system of claim 16, wherein the operation of determining the at least one protocol specification comprises: extracting a common attribute and a functional attribute for the cloud application from the message; acquiring at least one protocol template for the cloud application based on the extracted common and functional attributes; and determining the at least one protocol specification using the at least one protocol template and the extracted functional attribute.

18. The computing system of claim 16, wherein the operation of determining the at least one protocol specification comprises: writing a first protocol specification; if verification of the first protocol specification fails, writing a second protocol specification; and determining the second protocol specification as a protocol specification for implementing the workflow in response to verification of the second protocol specification being successful.

19. The computing system of claim 16, wherein the operation of determining the executable code for the cloud application comprises: acquiring a code template using at least one of the determined at least one protocol specification or the workflow; and determining the executable code for the cloud application based on the code template and the determined at least one protocol specification.

20. A non-transitory computer-readable recording medium comprising instructions,
wherein when executed by a processor, the instructions cause the processor to perform operations of: acquiring a message related to a cloud application; acquiring a workflow for the cloud application based on the message; determining at least one protocol specification for implementing the workflow; determining executable code for the cloud application using the determined at least one protocol specification and the workflow; and provisioning the cloud application using the determined executable code.
